(19) United States
(12) Patent Application Publication
(10) Pub. No.: US 2015/0006534 A1
(43) Pub. Date: Jan. 1, 2015

(54) EVALUATION SERVER, EVALUATION PROGRAM, AND EVALUATION METHOD

(71) Applicant: FUJITSU LIMITED, Kawasaki-shi (JP)

(72) Inventor: Makiko Konoshima, Yokohama (JP)

(21) Appl. No.: 14/485,215

(22) Filed: Sep. 12, 2014

Related U.S. Application Data
(63) Continuation of application No. PCT/JP2012/056941, filed on Mar. 16, 2012.

(51) Int. Cl. G06F 17/30

(52) U.S. Cl. CPC G06F 17/30598
USPC 707/737

(57) ABSTRACT

An evaluation server includes a memory and a processor coupled to the memory, wherein the processor executes a process includes creating, from a plurality of pieces of data in a database, matching data that is to be matched with the plurality of pieces of data, calculating matching time for each of the plurality of pieces of data in the database, the matching time being time taken to match each of the plurality of pieces of data with the matching data, and allocating the plurality of pieces of the data to a plurality of groups based on the matching time for each of the plurality of pieces of data.

### CROSS-REFERENCE TO RELATED APPLICATION

This application is a continuation of International Application No. PCT/JP2012/056941, filed on Mar. 16, 2012, the entire contents of which are incorporated herein by reference.

### FIELD

The embodiments discussed herein are directed to an evaluation server, an evaluation program, and an evaluation method.

### BACKGROUND

There is a conventional technology that matches input data with pieces of data that are accumulated in a database. For example, in fingerprint authentication in which a user is authenticated by using fingerprint data acquired from a fingertip of the user, an authentication result is output by matching fingerprint data acquired from the user's fingertip with pieces of fingerprint data that are previously registered in databases.

Furthermore, for example, there is a technology that, in distributed databases in which multiple storage devices connected to a network are integrally managed, previously stores the time taken to refer to data for each storage device and that allocates the storage locations of the data in accordance with the time.

Furthermore, for example, there is a system that creates a search condition for searching for a database as a structured query language (SQL) search string. In this system, there is a technology that executes the searching by using the created SQL search string and that displays the time taken to the searching for each SQL search string.
Patent Document 1: Japanese Laid-open Patent Publication No. 04-15839
Patent Document 2: Japanese Laid-open Patent Publication No. 2001-282799

However, in the conventional technologies described above, there is a problem in that it takes a long time to perform authentication. For example, in the fingerprint authentication described above, a large amount of fingerprint data related to several millions of people or tens of millions of people may sometimes be registered in a database. Consequently, when a user uses fingerprint authentication, because the fingerprint data that is read from the fingertip of the user is matched with, one by one, all pieces of fingerprint data that have been registered, it takes a long time to perform the authentication.

Furthermore, for example, it is conceivable that the fingerprint data registered in a database is distributed to multiple storage devices and multiple computing servers are allowed to perform the matching process in parallel. However, in this case, the authentication results are not able to be output until all of the matching processes that are executed in parallel have been completed. Accordingly, if a delay occurs in at least one of the matching processes, it takes a long time to perform the authentication.

This problem occurs not only when the above described fingerprint authentication is performed but also when biometric authentication that uses biometric information other than fingerprints, such as voiceprints, the vein pattern of palms, the iris of the eyeball, or the like. Furthermore, this problem is not limited to the biometric authentication. For example, the problem widely occurs when input data is matched with data stored in a database.

### SUMMARY

According to an aspect of an embodiment, an evaluation server includes a memory and a processor coupled to the memory, wherein the processor executes a process includes creating, from data in a database, matching data that is matched with the data; calculating, for each piece of the data in the database, matching time that is taken to match each of multiple pieces of data in the database with the created matching data; and allocating, on the basis of the calculated matching time, the multiple pieces of the data in the database to groups.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating the functional configuration of an evaluation server according to a first embodiment;

FIG. 2 is a schematic diagram illustrating an example of information stored in a fingerprint table;

FIG. 3 is a schematic diagram illustrating an example of information stored in a matching time table;

FIG. 4 is a schematic diagram illustrating an example of information stored in an allocation table;

FIG. 5 is a schematic diagram illustrating an example of the data structure of fingerprint data;

FIG. 6 is a schematic diagram illustrating a process of creating a pseudo query Q [0];

FIG. 7 is a schematic diagram illustrating a process of calculating the matching time;

FIG. 8 is a schematic diagram illustrating a process of calculating the matching time;

FIG. 9 is a schematic diagram illustrating a process of allocating fingerprint data to groups;

FIG. 10 is a flowchart illustrating the flow of a process performed by the evaluation server according to the first embodiment;

FIG. 11 is a block diagram illustrating the functional configuration of an evaluation server according to a second embodiment;

FIG. 12 is a flowchart illustrating the flow of a process performed by the evaluation server according to the second embodiment;

FIG. 13 is a block diagram illustrating the functional configuration of an evaluation server according to a third embodiment;

FIG. 14 is a flowchart illustrating the flow of a process performed by the evaluation server according to the third embodiment; and

FIG. 15 is a block diagram illustrating a computer that executes an evaluation program.

### DESCRIPTION OF EMBODIMENTS

Preferred embodiments of the present invention will be explained with reference to accompanying drawings. The present invention is not limited to the embodiments. Furthermore, the embodiments can be appropriately used in combination as long as the processes do not conflict with each other.

In the embodiments described below, the disclosed technology is used, as an example, in a case of fingerprint authentication in which a user is authenticated by using fingerprint data that is acquired from the fingertip of the user; however, the disclosed technology is not limited thereto. For example, the disclosed technology may also be used for the biometric authentication that used biometric information other than fingerprints, such as voiceprints, the vein pattern of palms, the iris of the eyeball, or the like. Furthermore, the disclosed technology can be widely used not only when the biometric authentication is performed but also when, for example, input data is matched with data in a database, when data that is most similar to input data is searched from pieces of data in a database, or the like.

### [a] First Embodiment

A description will be given of the functional configuration of an evaluation server 100 according to a first embodiment. The evaluation server 100 according to the first embodiment creates fingerprint data that is used to match the matching time related to each piece of registered fingerprint data. The evaluation server 100 calculates the matching time taken to match the created fingerprint data with the registered fingerprint data and then allocates the fingerprint data into groups such that the calculated matching time is equal. Consequently, when the matching process is performed in parallel, because the evaluation server 100 can perform the matching process for each group, the evaluation server 100 can equalize the load applied to the matching and reduce the time taken to perform the authentication.

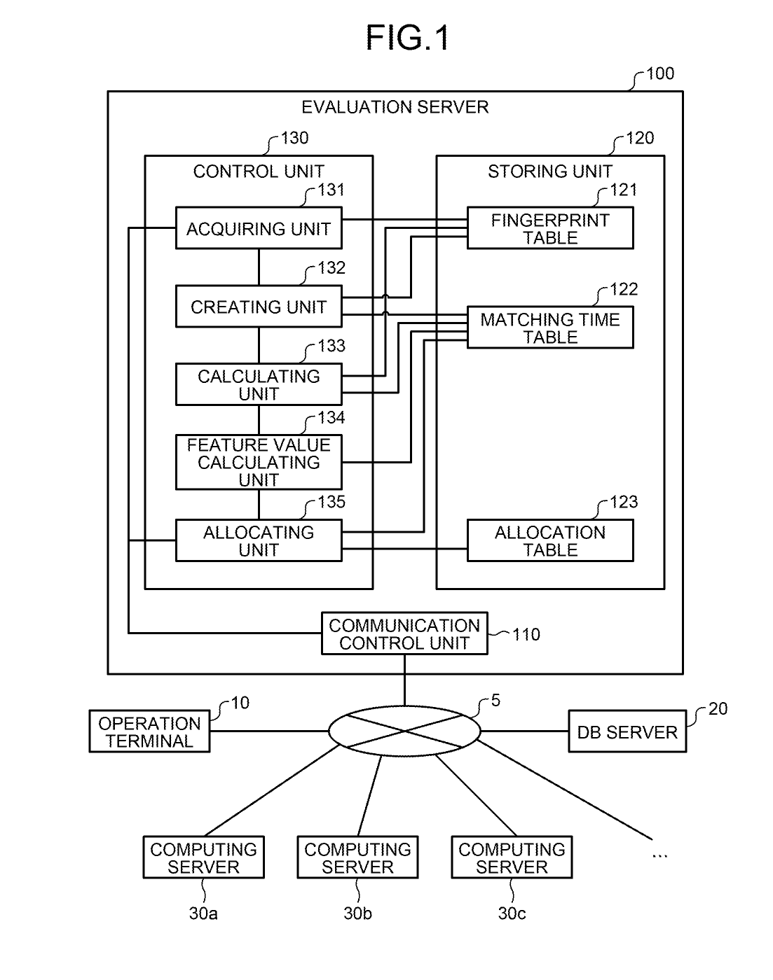

FIG. 1 is a block diagram illustrating the functional configuration of an evaluation server according to a first embodiment. As illustrated in FIG. 1, the evaluation server 100 is connected to, via a network 5, an operation terminal 10, a DB (Database) server 20, and computing servers 30a, 30b, and 30c.

Any kind of communication network, such as the LAN (Local Area Network) and a VPN (Virtual Private Network), may be used as the network 5 irrespective of whether the network is wired or wireless. Furthermore, in a description below, if there is no need to distinguish among the devices of the computing servers 30a, 30b, and 30c, they are collectively referred to as a computing server 30.

Furthermore, FIG. 1 illustrates a case, as an example, in which the operation terminal 10, the DB server 20, and the three computing servers 30 are connected to the evaluation server 100; however, the configuration is not limited to the configuration illustrated in FIG. 1. Specifically, an arbitrary number of the operation terminals 10, the DB servers 20, and the computing servers 30 may also be connected to the evaluation server 100. Furthermore, the evaluation server 100 may also be constituted by multiple server devices due to balancing the load.

The operation terminal 10 is a terminal operated by an administrator who manages the evaluation server 100 and is, for example, a personal computer, a workstation, or the like. For example, the operation terminal 10 receives, from the administrator, an input of an instruction to allow the evaluation server 100 to start a process and then the operation terminal 10 sends the received input instruction to the evaluation server 100.

The DB server 20 is an information management device that stores therein fingerprint data on a user who uses the fingerprint authentication. For example, the DB server 20 stores therein fingerprint data registered by the operation terminal 10. For example, the DB server 20 stores therein a fingerprint table 121, which will be described. In the example illustrated in FIG. 1, a description has been given of a case in which the single DB server 20 stores therein fingerprint data on all users who uses the fingerprint authentication; however, the disclosed technology is not limited thereto. For example, multiple DB servers 20 may also store therein fingerprint data on multiple users.

The computing server 30 is a server device that performs the fingerprint authentication. For example, by matching the fingerprint data received from a user terminal (not illustrated) with the fingerprint data that has already been registered and stored in the DB server 20, the computing server 30 authenticates the user.

In the following, a user terminal will be described. The user terminal is a terminal operated by a user who uses the fingerprint authentication and is, for example, a personal computer, a mobile phone, a smart phone, or the like. For example, the user terminal includes a fingerprint sensor that reads image data of a fingerprint; reads image data on fingerprint from the fingertip of the user who uses the fingerprint authentication; and then creates fingerprint data from the read image data. The fingerprint data mentioned here is created from image data in accordance with the matching algorithm. For example, in the matching algorithm using the minutiae method, the fingerprint data indicates the pattern of the end point or the branch point of the ridge of the fingerprint extracted from the image data. Then, when a user who uses the fingerprint authentication is registered, the user terminal sends the fingerprint data on the user to the DB server 20 and registers the sent fingerprint data in the DB server 20. Furthermore, when a user is authenticated by using the fingerprint authentication, the user terminal sends the fingerprint data on the user to the computing server 30. Furthermore, for example, the user terminal receives an authentication result from the computing server 30. Then, the user terminal displays the received authentication result or executes a process in accordance with the authentication result. For example, the user terminal permits a user whose authentication is successful to access predetermined information or to enter a predetermined location. Hereinafter, the fingerprint data that is sent by a user terminal and that is matched with the registered fingerprint data is also referred to as a “query”. Furthermore, a description has been given of a case in which the matching algorithm using the minutiae method is used; however, the disclosed technology is not limited to the minutiae method. For example, another matching algorithm, such as a pattern matching method or a frequency analyzing method, may also be used.

For example, the computing server 30 matches, by using a parallel process, a query with registered fingerprint data. For example, the computing server 30 acquires, from the DB server 20, fingerprint data that is to be matched with a query and stores the acquired fingerprint data in an internal memory (not illustrated). At this point, each of the computing servers 30 stores multiple pieces of fingerprint data in a distributed manner such that the multiple computing servers 30 store therein the fingerprint data on all users. Thereafter, when a query is received from the operation terminal 10, each of the computing servers 30 matches the received query with the fingerprint data stored in the internal memory in its own device and then sends a matching result to one of the multiple computing servers 30 that is previously specified. When a matching result is sent from each of the computing servers 30, the computing server 30 that has received the matching results aggregates the received matching results, creates an authentication result, and then sends the authentication result to the user terminal.

The evaluation server 100 creates, from fingerprint data registered in the DB server 20, a pseudo query that is a dummy query used to calculate the time taken to match the pieces of fingerprint data. The evaluation server 100 calculates, for each registered fingerprint data, the matching time taken to match the created pseudo query with the registered fingerprint data. The evaluation server 100 allocates the registered fingerprint data to each group such that the calculated matching time is equal. Consequently, when the matching process is performed in parallel, the evaluation server 100 can equalize the load applied to the matching and reduce the time taken to perform the authentication.

As illustrated in FIG. 1, the evaluation server 100 includes a communication control unit 110, a storing unit 120, and a control unit 130. The communication control unit 110 controls communication related to various kinds of information that are sent and received between, for example, the operation terminal 10, the DB server 20, the computing server 30, and the evaluation server 100. An example of the communication control unit 110 includes a network interface card (NIC).

The storing unit 120 includes, for example, the fingerprint table 121, a matching time table 122, and an allocation table 123. An example of the storing unit 120 includes a semiconductor memory device, such as a random access memory (RAM), a flash memory, or the like and a storage device, such as a hard disk device, an optical disk device, or the like.

The fingerprint table 121 stores therein fingerprint data on a user that uses the fingerprint authentication. For example, the fingerprint table 121 is stored by an acquiring unit 131, which will be described later. Furthermore, for example, the fingerprint table 121 is referred to by a creating unit 132 and a calculating unit 133, which will be described later.

For example, the fingerprint table 121 stores data therein, in an associated manner, a user ID and fingerprint data. The “user ID” mentioned here indicates the identifier used for identifying a user. The “fingerprint data” mentioned here indicates fingerprint data on a user.

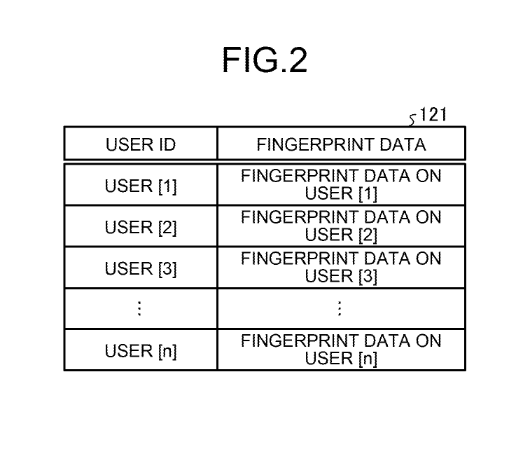

FIG. 2 is a schematic diagram illustrating an example of information stored in a fingerprint table. In the example illustrated in FIG. 2, the fingerprint table 121 stores therein data in which the user ID represented by the “user [1]” is associated with the fingerprint data represented by the “fingerprint data on the user [1]”. Furthermore, in the example illustrated in FIG. 2, in a similar manner as for the other pieces of fingerprint data, the fingerprint table 121 stores therein data in which the user ID is associated with the fingerprint data.

The matching time table 122 stores therein the matching time taken to match the pseudo query with the registered fingerprint data. For example, various kinds of information are stored in the matching time table 122 by the calculating unit 133 and a feature value calculating unit 134. Furthermore, for example, the matching time table 122 is referred to by the creating unit 132, the feature value calculating unit 134, and an allocating unit 135.

For example, the matching time table 122 stores therein data in which, in an associated manner, the user ID, the matching time taken to match a pseudo query, the average value, and a variance. The “matching time taken to match a pseudo query” mentioned here indicates the matching time taken to match a pseudo query with the registered fingerprint data. Furthermore, the “average value” mentioned here indicates the average value, for each piece of the fingerprint data, of the matching time taken to match the pseudo query. The “variance” mentioned here indicates the variance, for each piece of the fingerprint data, of the matching time taken to match a pseudo query.

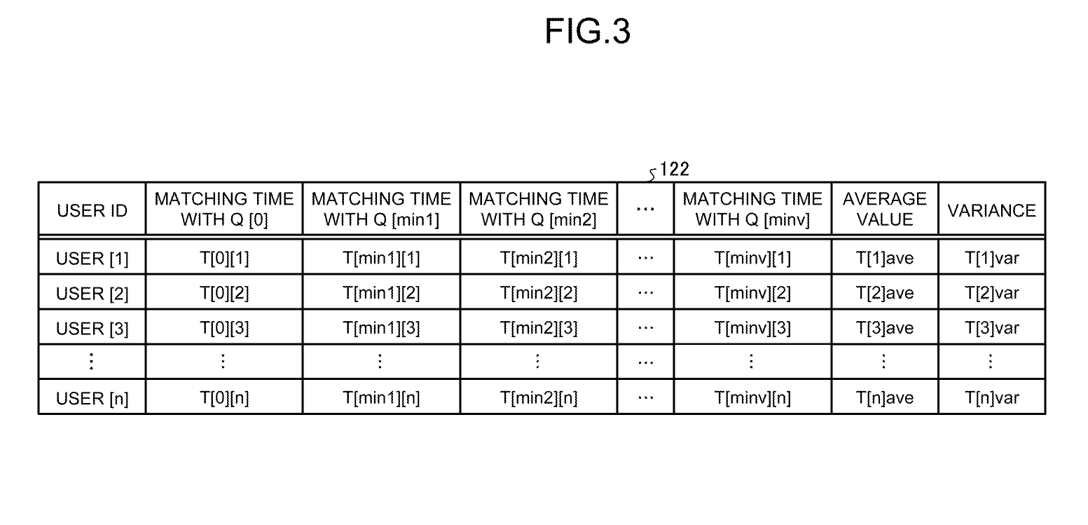

FIG. 3 is a schematic diagram illustrating an example of information stored in a matching time table. In the record in the first line illustrated in FIG. 3, the user ID of the “user [1]”, the matching time of “T [0][1]” taken to match the user ID of the “user [1]” with the pseudo query of Q [0], the matching time of “T [min1][1]” taken to match the user ID of the “user [1]” with a subsequent pseudo query of Q [min1], and . . . are associated with each other. This indicates that the matching time taken to match the fingerprint data on the user [1] with the pseudo query Q [0] is T [0][1] and indicates that the matching time taken to match the fingerprint data on the user [1] with the pseudo query Q [min1] is T [min1][1]. Furthermore, in the record in the first line illustrated in FIG. 3, in a similar manner as for the other pseudo queries, the matching time taken to match the fingerprint data on the user [1] with each of the pseudo queries is also associated with each other. Furthermore, in the record in the first line illustrated in FIG. 3, the average value of “T [1]ave” is associated with the variance of “T [1]var”. This indicates that the average value of the matching time taken to match the fingerprint data on the user [1] with the pseudo query is T [1]ave and indicates that the variance of the matching time taken to match the fingerprint data on the user [1] with the pseudo query is T [1]var. Furthermore, in a similar manner as for the other user IDs, the matching time table 122 stores therein data in which each of the user IDs, the matching time taken to match each of the user IDs with the pseudo query, the average value, and the variance are associated with each other.

The allocation table 123 stores therein the association relationship between a group and fingerprint data that is allocated to each group. For example, the allocation table 123 is stored by the allocating unit 135.

For example, the “chunk ID” indicates the identifier for identifying a chunk. The chunk mentioned here is a block of data and indicates, here, the fingerprint data that is allocated to a group.

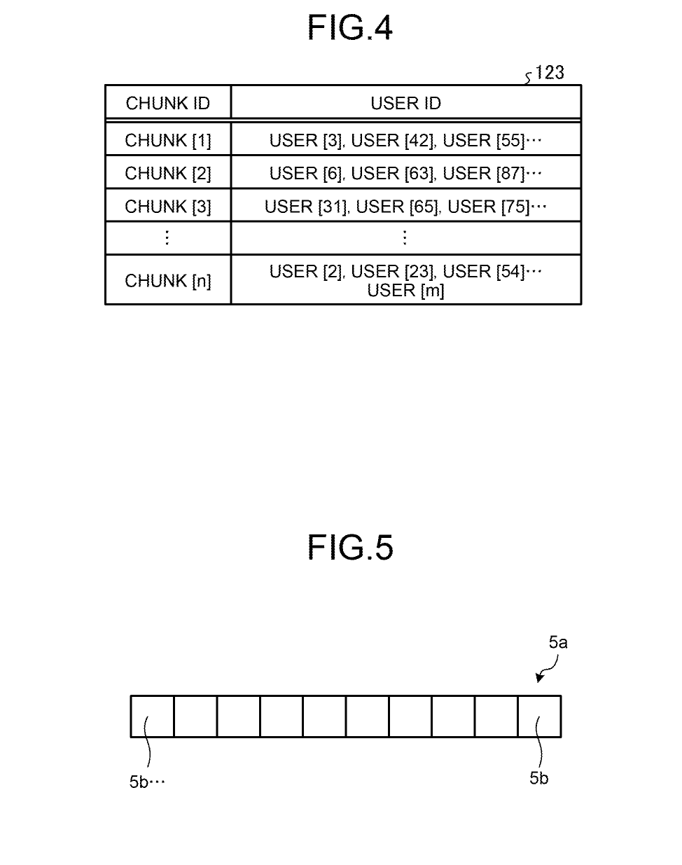

FIG. 4 is a schematic diagram illustrating an example of information stored in an allocation table. In the example illustrated in FIG. 4, the allocation table 123 stores therein data in which the chunk ID of “chunk [1]” and the user IDs of “user [3], user [42], user [55], and . . . ” are associated. This indicates that the fingerprint data on the user [3], the fingerprint data on the user [42], and the fingerprint data on the user [55], and . . . are allocated to the chunk [1]. Furthermore, in a similar manner as for the other chunk IDs, the allocation table 123 stores therein the association relationship between each of the chunk IDs and the fingerprint data that is allocated to each of the chunks.

The control unit 130 includes the acquiring unit 131, the creating unit 132, the calculating unit 133, the feature value calculating unit 134, and the allocating unit 135. The function performed by the control unit 130 can be implemented by, for example, an integrated circuit, such as an application specific integrated circuit (ASIC), a field programmable gate array (FPGA), or the like. Furthermore, the function performed by the control unit 130 can be implemented by executing a predetermined program performed by, for example, a central processing unit (CPU).

The acquiring unit 131 acquires, from the DB server 20, fingerprint data that is targeted for a process. For example, when the acquiring unit 131 receives, from the operation terminal 10, an input of an instruction from an administrator who manages the evaluation server 100 indicating that a process is to be started by the evaluation server 100, the acquiring unit 131 acquires, from the DB server 20, the fingerprint table 121 that includes therein the fingerprint data targeted for the process. Then, the acquiring unit 131 stores the acquired fingerprint data in the storing unit 120.

The creating unit 132 creates, from the data in the database, matching data that is matched with the data in the database. For example, the creating unit 132 creates, from the fingerprint data stored in the fingerprint table 121, a pseudo query that is a dummy query used to calculate the time taken to match the pieces of fingerprint data. The fingerprint data corresponds to an example of data and the pseudo query corresponds to an example of matching data.

For example, the creating unit 132 calculates the average value of elements that are included in the fingerprint data stored in the fingerprint table 121 and then creates, as a pseudo query Q [0], the average data in which the calculated average value is included in each of the elements. Then, the creating unit 132 outputs the pseudo query Q [0] to the calculating unit 133.

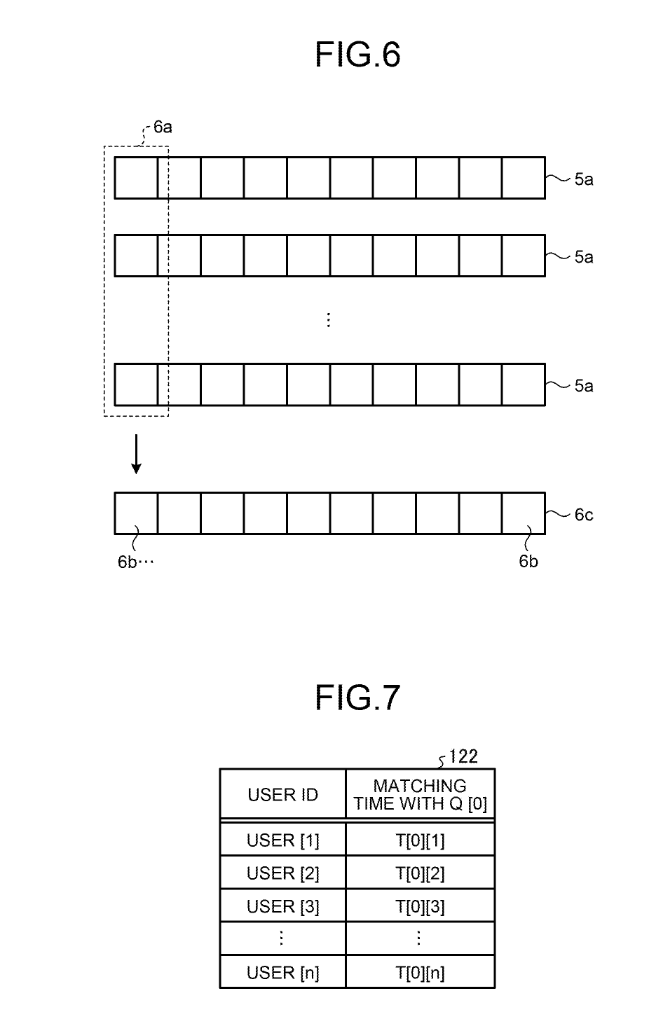

In the following, a process of calculating the pseudo query Q [0] performed by the creating unit 132 will be described with reference to FIGS. 5 and 6. FIG. 5 is a schematic diagram illustrating an example of the data structure of fingerprint data. As illustrated in FIG. 5, for example, fingerprint data 5a is defined as multidimensional array data that includes multiple elements 5b. The elements 5b are, for example, the patterns of an end point or a branch point of the ridge of a fingerprint that is extracted, for each of the elements 5b under a predetermined condition, from an image data of a fingerprint. The example indicates a case in which the fingerprint data 5a includes 10 elements 5b; however, the disclosed technology is not limited thereto. For example, the fingerprint data 5a may also include an arbitrary number of the elements 5b.

FIG. 6 is a schematic diagram illustrating a process of creating the pseudo query Q [0]. As illustrated in FIG. 6, for each of the elements 5b included in multiple pieces of the fingerprint data 5a, the creating unit 132 calculates each of the average values 6b of the associated elements 6a. Then, the creating unit 132 creates, as the pseudo query Q [0], average data 6c in which the calculated average values 6b of the associated elements 6a are included as elements. The example indicates a case in which the creating unit 132 creates the pseudo query Q [0] by calculating the average values of the associated elements included in the fingerprint data; however, the disclosed technology is not limited thereto. For example, the creating unit 132 may also randomly select a single piece of fingerprint data from the pieces of fingerprint data stored in the fingerprint table 121 and then use the selected fingerprint data as the pseudo query Q [0].

Furthermore, for example, from among the matching time for each piece of the fingerprint data calculated by the calculating unit 133, the creating unit 132 specifies the fingerprint data in which the minimum matching time is calculated. Then, the creating unit 132 outputs the specified fingerprint data as a pseudo query to the calculating unit 133.

The reason for the creating unit 132 creating a pseudo query from the registered fingerprint data is that, when authentication is performed, there is a high possibility that fingerprint data similar to the registered fingerprint data is input as a query. This intends to create a pseudo query that is similar to an actually input query.

A description will be given here by referring back to FIG. 1. The calculating unit 133 calculates, for each piece of target data, the matching time taken to match the created matching data with each of the multiple pieces of data in the database. For example, the calculating unit 133 matches the pseudo query created by the creating unit 132 with each pieces of the fingerprint data stored in the fingerprint table 121 and then measures the matching time for each piece of the fingerprint data. Then, the calculating unit 133 store the measured matching time in the matching time table 122. The calculating unit 133 measures the matching time taken to match the pseudo query with each of the fingerprint data until a predetermined number of pieces of the matching time is measured. When the calculating unit 133 measures the predetermined number of pieces of the matching time, the calculating unit 133 outputs the predetermined number of pieces of the matching time to the feature value calculating unit 134.

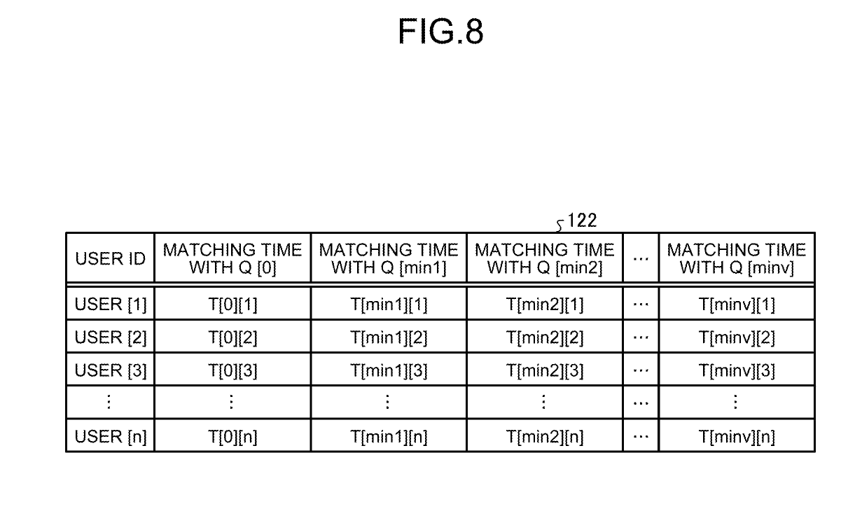

In the following, a process of calculating the matching time performed by the creating unit 132 and the calculating unit 133 will be described with reference to FIGS. 7 and 8. FIGS. 7 and 8 are schematic diagrams each illustrating a process of calculating the matching time.

As illustrated in FIG. 7, when the pseudo query Q [0] is created by the creating unit 132, the calculating unit 133 calculates the pieces of the matching time T [0][1] to T [0][n] taken to match the fingerprint data on each of the users with the user IDs of users [1] to [n] with the pseudo query Q [0]. Then, the calculating unit 133 stores the pieces of the matching time T [0][1] to T [0][n] taken to match with the pseudo query Q [0] in the matching time table 122.

When the pieces of the matching time T [0][1] to T [0][n] taken to match the pseudo query Q [0] are stored in the matching time table 122, the creating unit 132 specifies, as the subsequent pseudo query from among the pieces of the matching time T [0][1] to T [0][n], the fingerprint data in which the minimum matching time is calculated. For example, from among the pieces of the matching time T [0][1] to T [0][n], if the minimum matching time is T [0][2], the creating unit 132 specifies the fingerprint data on the user [2] as the subsequent pseudo query Q [min1]. The creating unit 132 outputs the specified pseudo query Q [min1] to the calculating unit 133.

When the pseudo query Q [min1] is specified by the creating unit 132, the calculating unit 133 calculates, as illustrated in FIG. 8, the pieces of the matching time T [min1][1] to T [min1][n] taken to match the fingerprint data on each of the users with the user IDs of the users [1] to [n] with the pseudo query Q [min1]. Then, the calculating unit 133 stores the pieces of the matching time T [min1][1] to T [min1][n] taken to match with the pseudo query Q [min1] in the matching time table 122. After that, every time the matching time taken to match with the pseudo query is stored in the matching time table 122, the creating unit 132 specifies, as the subsequent pseudo query from among the calculated pieces of the matching time, the fingerprint data in which the minimum matching time is calculated. For example, the creating unit 132 specifies the number of queries corresponding to [v+1] queries from among the pseudo queries Q [0] to Q [minv]. Furthermore, every time a pseudo query is specified by the creating unit 132, the calculating unit 133 calculates the matching time taken to match the fingerprint data on each of the users with the pseudo query. For example, for the fingerprint data on each of the users, the calculating unit 133 calculates the pieces of the matching time T [0][1] to T [minv][n] taken to match with the pseudo queries Q [0] to Q [minv], respectively. When the calculating unit 133 calculates the matching time taken to with the [v+1] queries, the calculating unit 133 outputs the calculated pieces of the matching time T [0][1] to T [minv][n] to the feature value calculating unit 134.

The reason for the calculating unit 133 calculating the matching time by using multiple pseudo queries is that the matching time varies depending on the combination of two pieces of data that are targeted for the matching. This intends to prevent the pieces of the matching time taken for fingerprint data from being concentrated in a specific value due to the matching time being calculated by using multiple pseudo queries. Furthermore, the reason for using the fingerprint data, in which the minimum matching time is calculated, from among the calculated pieces of the matching time in order to create multiple pseudo queries is that fingerprint data having different properties can be used as pseudo queries. This intends to prevent the pieces of the matching time taken to with for each piece of the fingerprint data from being concentrated in a specific value due to pieces of fingerprint data having the same property being created as pseudo queries.

A description will be given here by referring back to FIG. 1. The feature value calculating unit 134 calculates a feature value from multiple pieces of the matching time. For example, from the matching time calculated by the calculating unit 133, the feature value calculating unit 134 calculates, for each piece of the fingerprint data, the average value of the matching time and the variance of the matching time. The feature value calculating unit 134 stores the calculated average value and the variance in the matching time table 122. The average value of the matching time and the variance of the matching time correspond to an example of the feature value.

For example, the feature value calculating unit 134 calculates the sum of the pieces of the matching time T [0][1] to T [minv][1] and divides the calculated sum by a predetermined value [v+1], whereby the feature value calculating unit 134 calculates the average value T [1]ave of the matching time of the user [1]. Furthermore, the feature value calculating unit 134 calculates a difference between the pieces of the matching time T [0][1] to T [minv][1] and the average value T [1]ave and divides the sum of the square of each of the calculated differences by the predetermined value [v+1], whereby the feature value calculating unit 134 calculates the variance T [1]var of the matching time of the user [1]. The feature value calculating unit 134 stores the average value T [1]ave and the variance T [1]var in the matching time table 122. Furthermore, in a similar manner as for the pieces of the matching time of the other user IDs, the feature value calculating unit 134 calculates the average value T [n]ave and the variance T [n]var and stores the calculated values in the matching time table 122.

The allocating unit 135 allocates, on the basis of the calculated matching time, the multiple pieces of data in the database to a group. For example, the allocating unit 135 compares the feature values calculated by the feature value calculating unit 134 and then allocates fingerprint data to a group such that pieces of fingerprint data with feature values that are closer with each other are allocated to different groups when compared with pieces of the fingerprint data having greatly different feature values. Then, the allocating unit 135 stores, in the allocation table 123, the association relationship between the group and the fingerprint data that is allocated to each group.

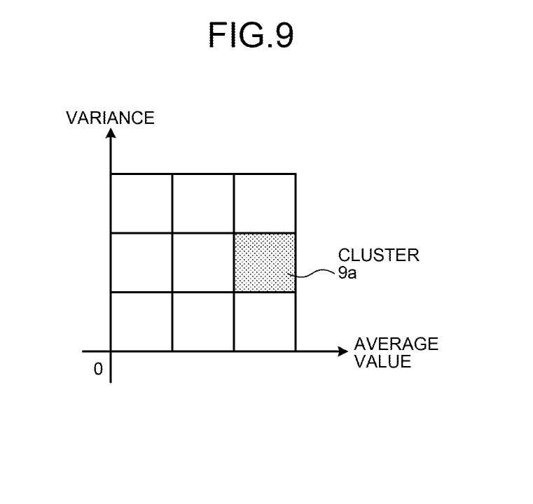

FIG. 9 is a schematic diagram illustrating a process of allocating fingerprint data to groups. As illustrated in FIG. 9, for example, the allocating unit 135 allocates fingerprint data on users on the coordinates in which the average value and the variance calculated by the feature value calculating unit 134 are used as two axes. Then, the allocating unit 135 performs clustering on the fingerprint data on the users on the coordinates. If the number of pieces of the fingerprint data included in a cluster reaches a predetermined number, the allocating unit 135 allocates the data included in the cluster to a chunk. In the example illustrated in FIG. 9, for example, the fingerprint data on the users included in a cluster 9a are closer to the average value and the variance when compared with the other pieces of the fingerprint data. Consequently, the allocating unit 135 allocates the fingerprint data on the users included in the cluster 9a to different chunks. For example, when the number of pieces of the fingerprint data on the users included in the cluster 9a becomes an integral multiple of the number of chunks, the allocating unit 135 equally allocates the pieces of the fingerprint data on the users to each chunk. Then, the allocating unit 135 stores, in the allocation table 123, the association relationship between the chunk IDs and the user IDs on the fingerprint data allocated to each chunk. The allocating unit 135 does not perform the allocation only when the number of pieces of the fingerprint data on the users reaches an integral multiple of the number of chunks. For example, the allocating unit 135 may allocate the fingerprint data to each of the chunks when the number of pieces of the fingerprint data on the users is greater than an integral multiple of the number of chunks. In such a case, the allocating unit 135 allocates the data to each of the chunks and then allocates the fingerprint data that has not been allocated to an appropriate chunk. Furthermore, a method of clustering the fingerprint data performed by the allocating unit 135 is not limited to the method described above. For example, any existing clustering method may also be used.

Furthermore, for example, the allocating unit 135 allocates chunks to each of the computing servers 30 such that the number of chunks to which each piece of fingerprint data is allocated becomes equal. For example, the allocating unit 135 divides the number of chunks to each of which the fingerprint data is allocated by the number of the computing servers 30, whereby the allocating unit 135 calculates the number of chunks to be allocated to each of the computing servers 30. The allocating unit 135 allocates the chunks the number of which corresponds to the calculated number of chunks to the computing server 30. The allocating unit 135 sends, to each of the computing servers 30, the user ID that is included in the chunk allocated to each of the computing servers 30. Consequently, the allocating unit 135 can allow each of the computing servers 30 to acquire the registered fingerprint data such that the matching time for each of the computing servers 30 is about the same.

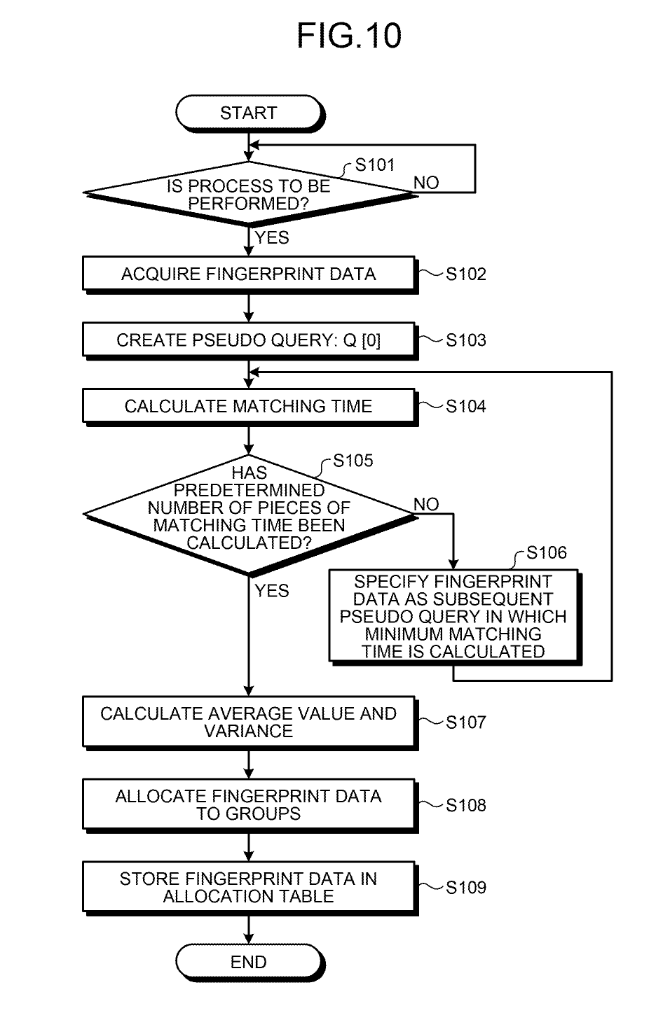

In the following, a description will be given of the flow of the process performed by the evaluation server according to the first embodiment. FIG. 10 is a flowchart illustrating the flow of a process performed by the evaluation server according to the first embodiment. The process illustrated in FIG. 10 is executed when, for example, the acquiring unit 131 receives, from the operation terminal 10, an input of an instruction to allow the evaluation server 100 to start the process.

As illustrated in FIG. 10, when a process is to be performed (Yes at Step S101), the acquiring unit 131 acquires the fingerprint data that is targeted for the process from the DB server 20 (Step S102). The creating unit 132 creates the pseudo query Q [0] from the fingerprint data that is acquired from the acquiring unit 131 (Step S103).

The calculating unit 133 calculates the matching time taken to match with the pseudo query that is created by the creating unit 132 (Step S104). Then, until a predetermined number of pieces of the matching time are calculated (No at Step S105), the calculating unit 133 specifies the fingerprint data as subsequent pseudo query in which the minimum matching time from among the calculated pieces of the matching time are calculated (Step S106) and then proceeds to the process at Step S104.

When the predetermined number of pieces of the matching time are calculated by the calculating unit 133 (Yes at Step S105), the feature value calculating unit 134 calculates, for each piece of the fingerprint data, the average value and the variance of the matching time (Step S107). On the basis of the average value and the variance calculated by the feature value calculating unit 134, the allocating unit 135 allocates the fingerprint data to a group (Step S108). Then, the allocating unit 135 stores, in the allocation table 123, the association relationship between the group and the fingerprint data allocated to each group (Step S109).

In the following, a description will be given of an advantage of the evaluation server according to the first embodiment. The evaluation server 100 according to the first embodiment creates, from the fingerprint data stored in the DB server 20, matching data that is to be matched with the fingerprint data. The evaluation server 100 calculates, for each piece of the fingerprint data, the matching time taken to match the created matching data with the multiple pieces of the fingerprint data stored in the DB server 20. The evaluation server 100 allocates, on the basis of the calculated matching time, the multiple pieces of the fingerprint data stored in the DB server 20 to a group. Consequently, when the matching process is performed in parallel, the evaluation server 100 can uniform the load applied when the matching is performed and thus reduce the time taken to perform the authentication.

For example, the evaluation server 100 can allocate each piece of the fingerprint data to a group such that the pieces of the matching time of the fingerprint data included in each group are equal. Consequently, by allowing each of the computing servers 30 to acquire the fingerprint data such that the number of groups is equal, the evaluation server 100 can make the load applied to the computing server 30 uniform. Consequently, the evaluation server 100 can prevent a delay that occurs in some of the matching processes that are performed by each of the computing servers 30 in parallel. Thus, the evaluation server 100 can reduce the time taken to perform the authentication.

### [b] Second Embodiment

In the first embodiment described above, a description has been given of a case in which the time taken to normalize the registered fingerprint data is not considered. Specifically, in the fingerprint authentication, when fingerprint data on a user is registered in the DB server 20, the fingerprint data may sometimes be registered in a state in which the orientation of the fingerprint that is read by a fingerprint sensor is rotated. In such a case, the matching is performed after the registered fingerprint data is normalized. However, in the first embodiment described above, a description has been given of a case of the matching time that includes the time taken to normalize the registered fingerprint data without considering the time taken for the normalization. However, the disclosed technology may also be used in a case in which the matching time is calculated by taking into consideration the time taken to normalize the registered fingerprint data. Accordingly, in a second embodiment, a description will be given of a case in which the matching time is calculated by taking into consideration the time taken to normalize the registered fingerprint data. In the second embodiment, when a query or a pseudo query is matched with the registered fingerprint data, adjustment of the rotation angle of the fingerprint of the registered fingerprint data is referred to as normalization; however, any process may also be used as long as the process adjusts various attributes of the registered fingerprint data.

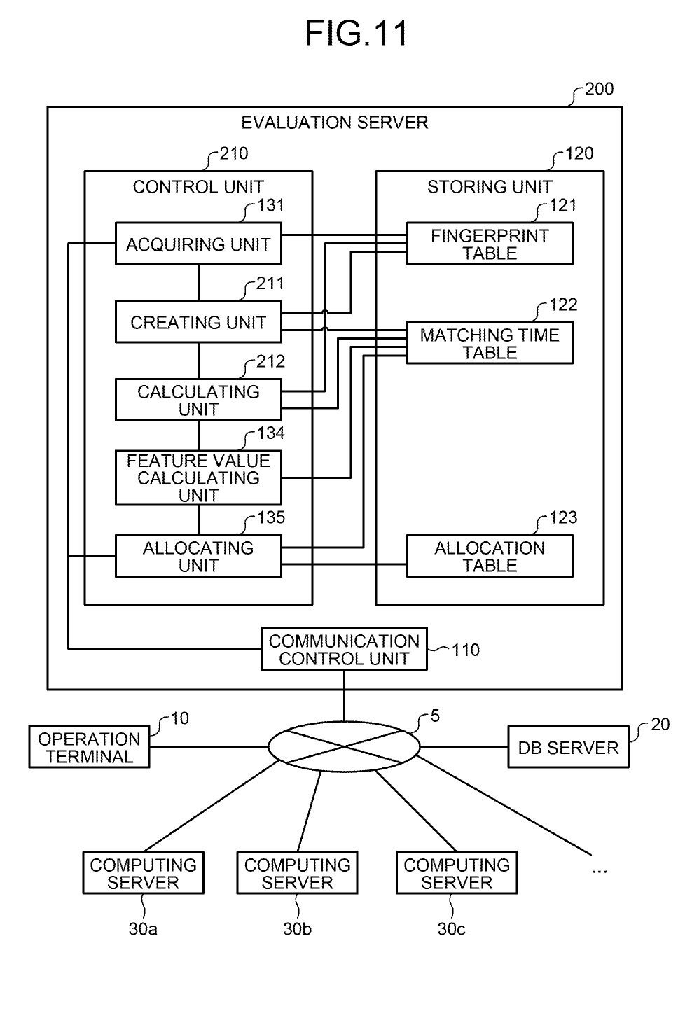

In the following, the functional configuration of an evaluation server 200 according to the second embodiment will be described. FIG. 11 is a block diagram illustrating the functional configuration of an evaluation server according to a second embodiment. As illustrated in FIG. 11, the evaluation server 200 includes the communication control unit 110, the storing unit 120, and a control unit 210. From among these units, the functions performed by the communication control unit 110 and the storing unit 120 illustrated in FIG. 11 are the same as those performed by the communication control unit 110 and the storing unit 120, respectively, illustrated in FIG. 1. Furthermore, in a description below, the functioning units having the same functions as those described in the first embodiment are assigned the same reference numerals; therefore, descriptions thereof will be omitted.

The control unit 210 includes the acquiring unit 131, a creating unit 211, a calculating unit 212, the feature value calculating unit 134, and the allocating unit 135. From among these units, the functions performed by the acquiring unit 131, the feature value calculating unit 134, and the allocating unit 135 illustrated in FIG. 11 are the same as those performed by the acquiring unit 131, the feature value calculating unit 134, and the allocating unit 135, respectively, illustrated in FIG. 1.

The creating unit 211 has the same function as that performed by the creating unit 132 illustrated in FIG. 1. Furthermore, the creating unit 211 creates pieces of matching data with multiple patterns that are used to normalize data. For example, for a created single pseudo query, the creating unit 211 creates pseudo queries with multiple patterns that are used to normalize the fingerprint data. The creating unit 211 outputs the created pseudo queries with multiple patterns to the calculating unit 212.

For example, the creating unit 211 divides the rotation angle, which is guaranteed in the system design in fingerprint authentication, into a predetermined number, i.e., u+1, and then creates pseudo queries Q [minv][0] to Q [minv][u] with u+1 patterns every time the creating unit 211 creates a single pseudo query Q [minv]. Then, the creating unit 211 outputs the pseudo queries Q [minv][0] to Q [minv][u] to the calculating unit 212.

For example, if the rotation angle of ±10 degrees is allowed in the system design, the creating unit 211 creates the pseudo queries Q [minv][1] to Q [minv][20] with 20 patterns that are obtained by rotating the pseudo query every ±1 degree. Accordingly, the calculating unit 212 creates the pseudo queries with 21 patterns that include pseudo query Q [minv][0] with the pattern that was obtained before the rotation. Then, the creating unit 211 outputs, to the calculating unit 212, the created pseudo queries Q [minv][0] to Q [minv][20] every time the creating unit 211 creates a single pseudo query Q [minv].

The calculating unit 212 has the same function as that performed by the calculating unit 133 illustrated in FIG. 1 and calculates the matching time taken to match the multiple pieces of the data stored in the database with the pieces of the matching data with multiple patterns created by the creating unit 211. Then, the calculating unit 212 selects a single piece of the matching time from among the pieces of the calculated matching time with multiple patterns and then stores the selected calculation time in the matching time table 122. For example, if the difference between the maximum value and the minimum value of the calculated matching time with the multiple patterns is less than a threshold, the calculating unit 212 selects the calculation time that has been calculated for the data. Furthermore, for example, if the difference between the maximum value and the minimum value of the calculated matching time with the multiple patterns is equal to or greater than the threshold, the calculating unit 212 selects the matching time with the pattern that has the maximum value.

For example, the calculating unit 212 calculates the matching time taken to match each of the pseudo queries Q [minv][0] to Q [minv][u] with u+1 patterns created by the creating unit 211 with each piece of the fingerprint data on the users with the user IDs of the users [1] to [n] stored in the fingerprint table 121. For example, the calculating unit 212 calculates the pieces of the matching time TC [0] to TC [u] taken to match the fingerprint data with the user ID of the user [n] with the pseudo queries Q [minv][0] to Q [minv][u]. Then, the calculating unit 212 calculates a difference q between the maximum value and the minimum value of the calculated pieces of the matching time TC [0] to TC [u]. Then, if the difference q is less than the threshold, the calculating unit 212 selects the matching time TC [0] that has been calculated for the pseudo query Q [minv][0] obtained before the normalization. In contrast, if the difference q is equal to or greater than the threshold, the calculating unit 212 selects the matching time with the pattern having the maximum value. For example, if the matching time TC [3] has the maximum value from among the pieces of the matching time TC [0] to TC [u], the calculating unit 212 selects the matching time TC [3]. In this example, a description has been given of a case in which, if the difference q is equal to or greater than the threshold, the matching time with the pattern having the maximum value is selected; however, the embodiment is not limited thereto. For example, it may also be possible to calculate the average value of the calculated pieces of the matching time TC [0] to TC [u] and then store the calculated average value in the matching time table 122.

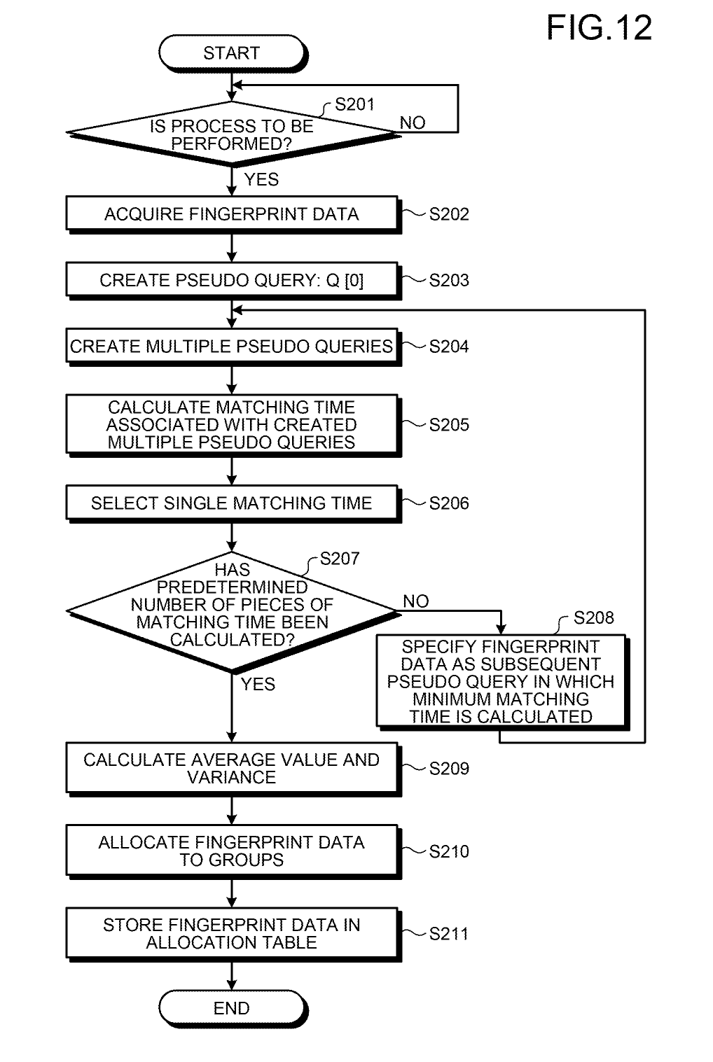

In the following, a description will be given of the flow of a process performed by the evaluation server according to the second embodiment. FIG. 12 is a flowchart illustrating the flow of a process performed by the evaluation server according to the second embodiment. The processes illustrated in FIG. 12 are performed when, for example, the acquiring unit 131 receives, from the operation terminal 10, an input of an instruction to allow the evaluation server 200 to start the processes.

As illustrated in FIG. 12, when a process is to be performed (Yes at Step S201), the acquiring unit 131 acquires the fingerprint data targeted for the process from the DB server 20 (Step S202). The creating unit 211 creates the pseudo query Q [0] from the fingerprint data acquired by the acquiring unit 131 (Step S203).

The creating unit 211 creates pseudo queries with multiple patterns with respect to the created single pseudo query (Step S204). For example, the creating unit 211 creates the pseudo queries Q [0][0] to Q [0][u] with u+1 patterns with respect to the pseudo query Q [0]. Furthermore, for example, the creating unit 211 creates the pseudo queries Q [minv][0] to Q [minv][u] with u+1 patterns with respect to the pseudo query Q [minv].

For the pseudo queries with multiple patterns created by the creating unit 211, the calculating unit 212 calculates the pieces of the matching time each of which is associated with each pattern (Step S205). For example, the calculating unit 212 calculates the pieces of the matching time TC [0] to TC [u] taken to match the fingerprint data on the user [n] with the pseudo queries Q [minv][0] to Q [minv][u].

Then, the calculating unit 212 selects a single piece of the matching time from among the calculated pieces of the matching time with multiple patterns (Step S206). For example, the calculating unit 212 calculates the difference q between the maximum value and the minimum value from among the calculated pieces of the matching time TC [0] to TC [u]. If the difference q is less than the threshold, the calculating unit 212 selects the matching time TC [0] that has been calculated for the pseudo query Q [minv][0] that was obtained before the normalization. In contrast, it the difference q is equal to or greater than the threshold, the calculating unit 212 selects the matching time with the pattern having the maximum value. For example, if the matching time TC [3] has the maximum value from among the pieces of the matching time TC [0] to TC [u], the calculating unit 212 selects the matching time TC [3].

Then, until a predetermined number of pieces of the matching time are stored in the matching time table 122 (No at Step S207), the calculating unit 212 specifies the fingerprint data as subsequent pseudo query in which the matching time having the minimum value is calculated from among the predetermined number of pieces of the stored matching time (Step S208) and then proceeds to Step S204.

If the predetermined number of pieces of the matching time are stored by the calculating unit 212 (Yes at Step S207), the feature value calculating unit 134 calculates the average value and the variance of the pieces of the matching time for each piece of the fingerprint data (Step S209). The allocating unit 135 allocates the pieces of the fingerprint data to groups on the basis of the average value and the variance calculated by the feature value calculating unit 134 (Step S210). Then, the allocating unit 135 stores, in the allocation table 123, the association relationship between the groups and the pieces of the fingerprint data allocated to each of the groups (Step S211).

In the following, a description will be given of an advantage of the evaluation server according to the second embodiment. The evaluation server 200 according to the second embodiment creates pieces of matching data with multiple patterns that are used to normalize data. The evaluation server 200 calculates the matching time taken to match multiple pieces of data in the database with the pieces of created matching data with multiple patterns. Consequently, the evaluation server 200 can evaluate the matching time by taking into consideration the time taken to normalize the registered fingerprint data.

In the second embodiment, a description has been given of the fingerprint data as an example of a case in which the matching time is calculated by taking into consideration the time taken for the normalization; however, the disclosed technology is not limited thereto. For example, the disclosed technology may also be used in a case in which the time taken to normalize audio data that is expanded or reduced in the time direction of the voiceprint authentication is taken into consideration or a case in which the time taken to normalize a rotated image data in vein authentication or the like is taken into consideration.

### [c] Third Embodiment

In the embodiments described above, descriptions have been given of a case in which fingerprint data that has not yet been allocated to a group is allocated to the group. However, there may be a case in which, after fingerprint data has been allocated to a group, the fingerprint data on a user is additionally added or deleted or may be a case in which data is updated by taking into consideration a change of biometric information over the years. In such a case, because the load applied for the matching of each group varies, the fingerprint data that has already allocated to a group need to be re-allocated; however, the disclosed technology can be used in this case. Accordingly, in a third embodiment, a description will be given of a case in which fingerprint data that has already been allocated to a group is re-allocated.

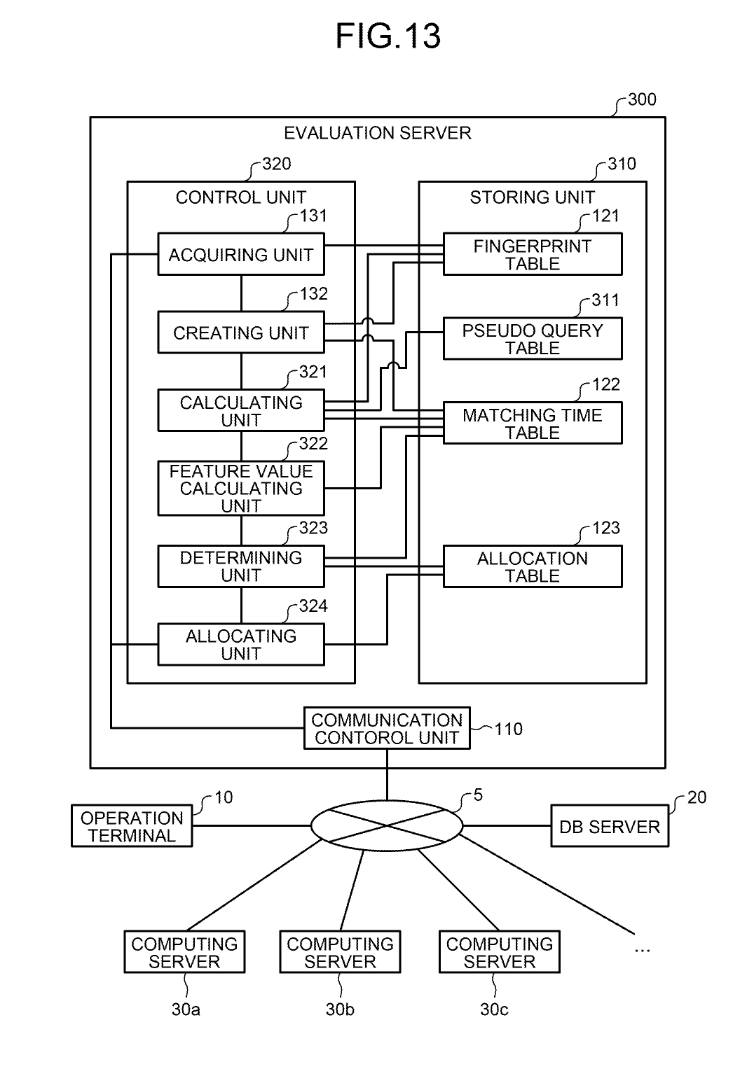

In the following, a description will be given of the functional configuration of an evaluation server 300 according to the third embodiment. FIG. 13 is a block diagram illustrating the functional configuration of an evaluation server according to a third embodiment. As illustrated in FIG. 13, the evaluation server 300 includes the communication control unit 110, a storing unit 310, and a control unit 320. From among these units, the function performed by the communication control unit 110 illustrated in FIG. 13 is the same as that performed by the communication control unit 110 illustrated in FIG. 1.

The storing unit 310 includes, for example, the fingerprint table 121, a pseudo query table 311, the matching time table 122, and the allocation table 123. From among these units, the functions performed by the fingerprint table 121, the matching time table 122, and the allocation table 123 illustrated in FIG. 13 are the same as those performed by the fingerprint table 121, the matching time table 122, and the allocation table 123, respectively, illustrated in FIG. 1.

The pseudo query table 311 stores therein a pseudo query that is immediately previously created. For example, the pseudo query table 311 stores therein a pseudo queries Q′ [0], a pseudo query Q′ [min1], a pseudo query Q′ [min2] . . . , and a pseudo query Q′ [minv] that are created by the creating unit 132. Furthermore, for example, in the pseudo query table 311, every time a pseudo query is created by the creating unit 132, the created pseudo query is stored by the creating unit 132.

The control unit 320 includes the acquiring unit 131, the creating unit 132, a calculating unit 321, a feature value calculating unit 322, a determining unit 323, and an allocating unit 324. From among these units, the functions performed by the acquiring unit 131 and the creating unit 132 illustrated in FIG. 13 are the same as those performed by the acquiring unit 131 and the creating unit 132, respectively, illustrated in FIG. 1.

The calculating unit 321 has the same function as that performed by the calculating unit 133 illustrated in FIG. 1. Furthermore, if the pseudo query that has been immediately previously created is stored in the pseudo query table 311, the calculating unit 321 calculates, for each piece of the fingerprint data, the matching time taken to match each of the pseudo queries that are immediately previously created with each of the pieces of the fingerprint data stored in the fingerprint table 121. For example, the calculating unit 321 calculates, for each piece of the fingerprint data, the matching time T′ [0][1] to T′ [0][n] taken to match the pseudo query Q′ [0], pseudo query Q′ [min1], . . . , and pseudo query Q′ [minv] with the pieces of the fingerprint data on each of the users with the user IDs of the users [1] to [n].

The feature value calculating unit 322 has the same function as that performed by the feature value calculating unit 134 illustrated in FIG. 1. Furthermore, when the matching time taken to match with the immediately previously created pseudo query is calculated by the calculating unit 321, the feature value calculating unit 322 calculates, for each piece of the fingerprint data, the average value of the pieces of the matching time taken to match with the immediately previously created pseudo query and the variance of the pieces of the matching time.

Specifically, the feature value calculating unit 322 calculates the sum of the matching time T′ [0][1] to T′ [minv][1] and divides the calculated sum by a predetermined value [v+1], whereby the feature value calculating unit 322 calculates the average value T′ [1]ave of the matching time of the user [1]. Furthermore, the feature value calculating unit 322 calculates the difference between the pieces of the matching time T′ [0][1] to T′ [minv][1] and the average value T′ [1]ave and divides the sum of the square of each of the calculated differences by the predetermined value [v+1]. Consequently, the feature value calculating unit 322 calculates the variance T′ [1]var of the pieces of the matching time of the user [1]. The feature value calculating unit 322 outputs the average value T′ [1]ave and the variance T′ [1]var to the determining unit 323. Furthermore, in a similar manner as for the matching time of the other user IDs, the feature value calculating unit 322 calculates the average value T′ [n]ave and the variance T′ [n]var and then outputs the calculated values to the determining unit 323 and the allocating unit 324.

The determining unit 323 compares the calculated first matching time with the second matching time that is taken to match the matching data created at the immediately previous allocation with the multiple pieces of data in the database and then determines, on the basis of the comparison result, whether the data is allocated to groups. For example, the determining unit 323 compares, for each chunk, the immediately previous calculated matching time with the matching time calculated this time and then determines, on the basis of the comparison result, whether the fingerprint data is allocated to the groups.

For example, the determining unit 323 acquires, from the allocation table 123, the association relationship between the chunk ID and the user ID of the fingerprint data that is currently allocated to each chunk. Then, the determining unit 323 calculates, for each chunk, the average value of pieces of the matching time related to the fingerprint data that is currently allocated. Specifically, for the chunk [1], the determining unit 323 calculates the sum of the matching time T′ [3]ave of the user [3], the matching time T′ [42]ave of the user [42], and . . . included in the chunk [1]. Then, the determining unit 323 divides the calculated sum by the number of pieces of the fingerprint data included in the chunk [1], whereby the determining unit 323 calculates the Txave′ [1].

Furthermore, the determining unit 323 acquires, from the allocating unit 324 on the basis of the matching time T [0] [1] to T [minv] [n], the user ID of the pieces of the fingerprint data allocated to each chunk. Then, the determining unit 323 calculates, for each chunk, the average value of the pieces of the matching time related to the allocated fingerprint data. Specifically, for the chunk [1], the determining unit 323 calculates the sum of the matching time T [3]ave of the user [3], the matching time T [42]ave of the user [42], and . . . included in the chunk [1]. Then, the determining unit 323 divides the calculated sum by the number of pieces of the fingerprint data included in the chunk [1] and calculates the Txave [1].

Then, the determining unit 323 calculates the difference between the Txave′ [1] calculated about the chunk [1] and the Txave [1] and then compares the calculated difference with the threshold. Furthermore, in a similar manner as for the other chunk [m], the determining unit 323 calculates the Txave′ [m] and the Txave [m] and compares the difference between the calculated Txave′ [m] and the Txave′ [m] with the threshold. If the number of chunks in which the calculated difference is equal to or greater than the threshold exceeds the predetermined number, the determining unit 323 determines that the allocation is to be performed. The determining unit 323 outputs the determination result to the allocating unit 324.

The allocating unit 324 has the same function as that performed by the allocating unit 135 illustrated in FIG. 1. Furthermore, if the determining unit 323 determines that allocation is to be performed, the allocating unit 324 allocates the fingerprint data to groups.

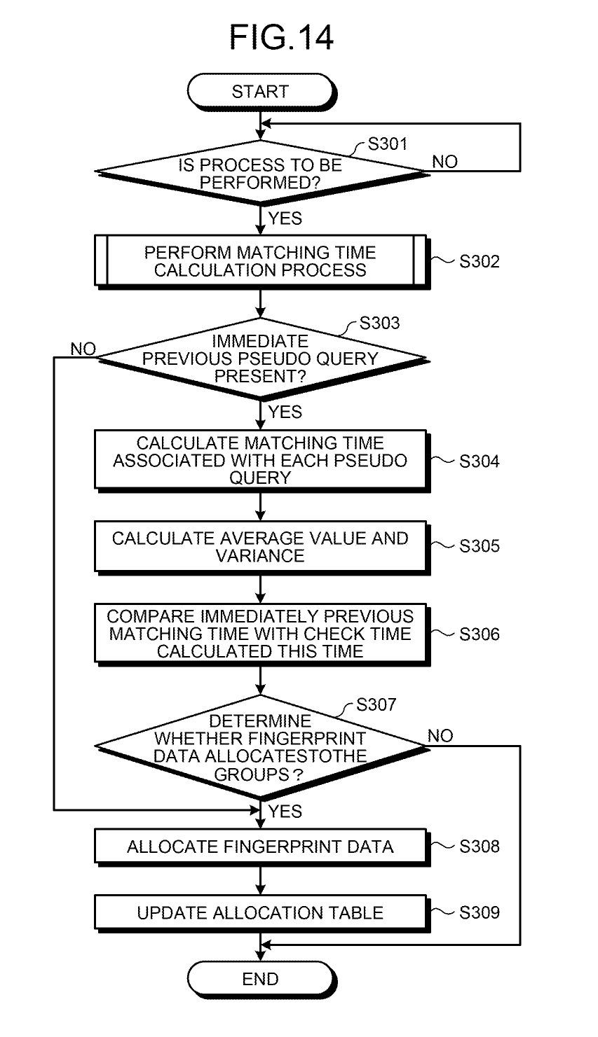

In the following, a description will be given of the flow of the processes performed by the evaluation server according to the third embodiment. FIG. 14 is a flowchart illustrating the flow of a process performed by the evaluation server according to the third embodiment. The processes illustrated in FIG. 14 are performed when, for example, the acquiring unit 131 receives, from the operation terminal 10, an input of an instruction to allow the evaluation server 300 to start the processes.

As illustrated in FIG. 14, when a process is to be performed (Yes at Step S301), the evaluation server 300 performs a matching time calculation process (Step S302). This matching time calculation process corresponds to the processes performed at Steps S102 to S107 illustrated in FIG. 10; therefore, descriptions thereof will be omitted.

If the immediately previously created pseudo query is stored in the pseudo query table 311 (Yes at Step S303), the calculating unit 321 calculates, for each piece of the fingerprint data, the matching time taken to match each of the pseudo queries that are immediately previously created with each piece of the fingerprint data (Step S304). If the immediately previously created pseudo query is not stored in the pseudo query table 311 (No at Step S303), the process proceeds to Step S308.

Then, the feature value calculating unit 322 calculates, for each piece of the fingerprint data, the average value and the variance of the pieces of the matching time taken to match with the immediately previously created pseudo query (Step S305). The determining unit 323 compares, for each chunk, the matching time that is immediately previously calculated with the matching time that is calculated this time (Step S306). The determining unit 323 determines, on the basis of the comparison result, whether the fingerprint data allocates to the groups (Step S307).

If the determining unit 323 determines that the allocation is to be performed (Yes at Step S307), the allocating unit 135 allocates the fingerprint data to the groups on the basis of the average value and the variance calculated by the feature value calculating unit 134 (Step S308). Then, the allocating unit 135 updates the association relationship between the groups and the pieces of fingerprint data allocated to the groups stored in the allocation table 123 (Step S309).

In contrast, if the determining unit 323 determines that the allocation is not to be performed (No at Step S307), the evaluation server 300 ends the process.

In the following, a description will be given of an advantage of the evaluation server according to the third embodiment. The evaluation server 300 according to the third embodiment compares the calculated first matching time with the second matching time taken to match the matching data created at the immediately previous allocation with the multiple pieces of data in the database. The evaluation server 300 determines, on the basis of the comparison result, whether the data is allocated to groups. Consequently, in a case the fingerprint data on the user is additionally added, deleted or changed over the years associated with biometric information, the evaluation server 300 can reallocate the fingerprint data on a user that has already been allocated to the group.

### [d] Fourth Embodiment

In the above explanation, a description has been given of the embodiments of the device according to the present invention; however, the present invention can be implemented with various kinds of embodiments other than the embodiments described above. Therefore, another embodiment will be described below.

For example, in the embodiments described above, a description has been given of a case in which the disclosed technology is used for the fingerprint authentication; however, the disclosed technology is not limited thereto. For another example, the disclosed technology may also be used in biometric authentication that uses biometric information other than fingerprints, such as voiceprints, the vein pattern of palms, the iris of the eyeball, and the like or may also be used in a voice search that searches for audio data that is very much alike in input voice, an image search that searches for an image data that is very much alike an input image, or the like.

Furthermore, for example, in the embodiments described above, a description has been given of a case in which multiple pseudo queries are created by the creating unit 132 repeatedly specifying the fingerprint data in which the minimum or the maximum of the matching time is calculated from the matching time that is calculated by the calculating unit 133; however, the disclosed technology is not limited thereto. For example, the creating unit 132 may also randomly select the multiple pieces of the fingerprint data from among the pieces of the fingerprint data stored in the fingerprint table 121 and may create the selected pieces of fingerprint data as pseudo queries.

Furthermore, of the processes described in the embodiments, the whole or a part of the processes that are mentioned as being automatically performed can also be manually performed, or the whole or a part of the processes that are mentioned as being manually performed can also be automatically performed using known methods. Furthermore, the flow of the processes, the control procedures, the specific names, and the information containing various kinds of data or parameters indicated in the above specification and drawings can be arbitrarily changed unless otherwise noted.

Furthermore, the components of the evaluation servers 100, 200, and 300 illustrated in FIGS. 1, 11, and 13 are only for conceptually illustrating the functions thereof and are not always physically configured as illustrated in the drawings. In other words, the specific shape of the separate or integrated evaluation servers 100, 200, and 300 is not limited to the drawings. Specifically, all or part of the device can be configured by functionally or physically separating or integrating any of the units depending on various loads or use conditions.

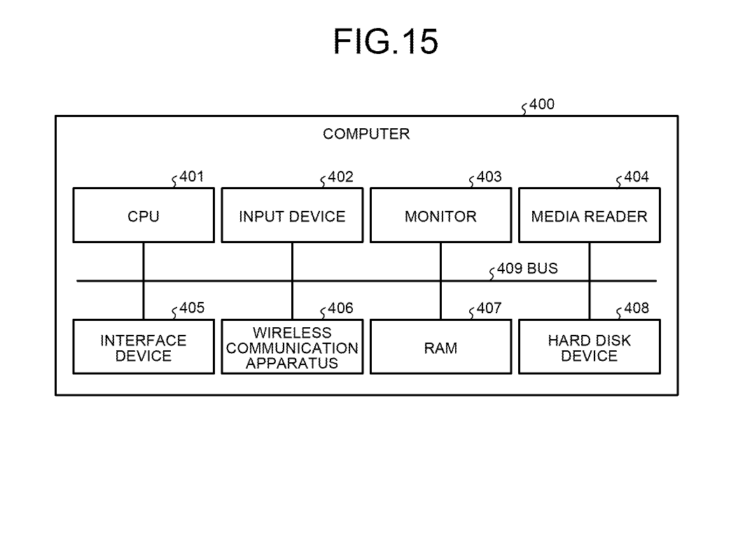

FIG. 15 is a block diagram illustrating a computer that executes an evaluation program. As illustrated in FIG. 15, a computer 400 includes a CPU 401 that executes various arithmetic processing, an input device 402 that receives an input of data from a user, and a monitor 403. Furthermore, the computer 400 includes a media reader 404 that read a program or the like from a storage medium and an interface device 405 that is used to connect to another device, and a wireless communication apparatus 406 that is used to wirelessly connect to another device. Furthermore, the computer 400 includes a random access memory (RAM) 407 that temporarily stores therein various kinds of information and a hard disk device 408. Furthermore, each of the devices 401 to 408 is connected to a bus 409.

The hard disk device 408 stores therein an evaluation information input program having the same function as that performed by each of the processing unit, such as the creating units 132 and 211, the calculating units 133, 212, and 321, and the allocating units 135 and 324 illustrated in FIGS. 1, 11, and 13. Furthermore, the hard disk device 408 stores therein various data for implementing an evaluation program.

The CPU 401 reads the programs stored in the hard disk device 408, loads the programs in the RAM 407, and executes the programs, thereby performing various processes. Furthermore, these programs allow a computer to function as the creating units 132 and 211, the calculating units 133, 212, and 321, and the allocating units 135 and 324 illustrated in FIGS. 1, 11, and 13.

The evaluation programs described above are not always stored in the hard disk device 408. For example, the computer 400 may also read and execute programs stored in a computer readable recording medium. Examples of the computer readable recording medium include a portable recording medium, such as a CD-ROM, a DVD disk, a universal serial bus (USB) memory, or the like, a semiconductor memory, such as a flash memory or the like, and a hard disk drive. Furthermore, the program may also be stored in a device connected to, for example, a public circuit, the Internet, a local area network (LAN), a wide area network (WAN), or the like and the computer 400 may also read and execute the program from the recording medium described above.

According to an aspect of an embodiment of the present invention, an advantage is provided in that the time taken to perform authentication can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An evaluation server comprising:
a memory; and
a processor coupled to the memory, wherein the processor executes a process comprising:
creating, from a plurality of pieces of data in a database, matching data that is to be matched with the plurality of pieces of data;
calculating matching time for each of the plurality of pieces of data in the database, the matching time being time taken to match each of the plurality of pieces of data with the matching data; and
allocating the plurality of pieces of the data to a plurality of groups based on the matching time for each of the plurality of pieces of data.

2. The evaluation server according to claim 1, wherein
the creating includes creating multiple pieces of matching data that are used to normalize the plurality of pieces of data, and
the calculating the matching time includes calculating, for each of the plurality of pieces of data, the matching time being time taken to match each of the plurality of pieces of data with each of a plurality of pieces of the created matching data.

3. The evaluation server according to claim 1, wherein the process further comprises
calculating a feature value from multiple pieces of the matching time, wherein
the creating includes creating a plurality of pieces of matching data,
the calculating the matching time includes calculating, for each of the plurality of pieces of the data, matching time being time taken to match each of the plurality of pieces of the data with each of the plurality of pieces of the matching data,
the calculating the feature value includes calculating, for each of the plurality of pieces of data, a feature value from a plurality of pieces of the calculated matching time, and
the allocating includes comparing the calculated feature values and allocating each of the plurality of pieces of the data in a group such that pieces of data having closer feature values are allocated to different groups when compared with pieces of data having greatly different feature values.

4. The evaluation server according to claim 3, wherein
the creating includes specifying, from among the pieces of the calculated matching time for each of the plurality of pieces of data in the database, a piece of data in which the minimum matching time is calculated as subsequent matching data, until a predetermined number of the matching time is calculated,
the calculating the matching time includes calculating, for each of the plurality of pieces of data, matching time taken to match each of the plurality of pieces of data with the subsequent matching data, until the predetermined number of the matching time is calculated.

5. The evaluation server according to claim 3, wherein
the calculating the feature value includes calculating, as the feature value and for each of the plurality of pieces of data, the average value of the matching time and the variance of the matching time, and
the allocating includes allocating the plurality of pieces of data on the coordinates in which the calculated average value and the calculated variance are used as two axes, performing clustering on the plurality of pieces of data on the coordinates, and allocating, when the number of pieces of the data included in a cluster reaches a predetermined value, the data included in the cluster to the different groups.

6. The evaluation server according to claim 1, wherein
the calculating the feature value includes calculating, as the feature value and for each plurality of pieces of the data, the average value of the matching time and the variance of the matching time, and
the allocating includes allocating the plurality of pieces of the data on the coordinates in which the calculated average value and the calculated variance are used as two axes, performing clustering on the plurality of pieces of data on the coordinates, and allocating, when the number of pieces of the data included in a cluster reaches a predetermined value, the data included in the cluster to the different groups.

7. The evaluation server according to claim 1, wherein the process further comprises comparing calculated first matching time calculated immediately with second matching time being time taken to match the matching data that is to be created when immediately previous allocation is performed at the allocating with each of the plurality of pieces of data in the database and determining, on the basis of a comparison result, whether the plurality of pieces of data are allocated to the groups, wherein
when it is determined that the plurality of pieces of data are allocated to the groups, the allocating includes allocating the plurality of pieces of data to the groups.

8. A non-transitory computer-readable recording medium having stored therein an evaluation program causing a computer to execute a process comprising:
creating, from a plurality of pieces of data in a database, matching data that is to be matched with the plurality of pieces of data;
calculating matching time for each of the plurality of pieces of data in the database, the matching time being time taken to match each of the plurality of pieces of data with the matching data; and
allocating the plurality of pieces of data to a plurality of groups based on the matching time for each of the plurality of pieces of data.

9. The non-transitory computer-readable recording medium according to claim 8, wherein
the creating includes creating multiple pieces of matching data that are used to normalize the plurality of pieces of data, and
the calculating the matching time includes calculating, for each of the plurality of pieces of data, the matching time being time taken to match each of the plurality of pieces of data with each of a plurality of pieces of the created matching data.

10. The non-transitory computer-readable recording medium according to claim 8, wherein the process further comprises calculating a feature value from multiple pieces of the matching time, wherein
the creating includes creating a plurality of pieces of matching data,
the calculating the matching time includes calculating, for each of the plurality of pieces of the data, matching time being time taken to match each of the plurality of pieces of the data with each of the plurality of pieces of the matching data,
the calculating the feature value includes calculating, for each of the plurality of pieces of data, a feature value from a plurality of pieces of the calculated matching time, and
the allocating includes comparing the calculated feature values and allocating each of the plurality of pieces of the data in a group such that pieces of data having closer feature values are allocated to different groups when compared with pieces of data having greatly different feature values.

11. The non-transitory computer-readable recording medium according to claim 10, wherein
the creating includes specifying, from among the pieces of the calculated matching time for each of the plurality of pieces of data in the database, a piece of data in which the minimum matching time is calculated as subsequent matching data, until a predetermined number of the matching time is calculated,
the calculating the matching time includes calculating, for each of the plurality of pieces of data, matching time taken to match each of the plurality of pieces of the data with the subsequent matching data, until the predetermined number of the matching time is calculated.

12. The non-transitory computer-readable recording medium according to claim 10, wherein
the calculating the feature value includes calculating, as the feature value and for each of the plurality of pieces of data, the average value of the matching time and the variance of the matching time, and
the allocating includes allocating the plurality of pieces of data on the coordinates in which the calculated average value and the calculated variance are used as two axes, performing clustering on the plurality of pieces of data on the coordinates, and allocating, when the number of pieces of the data included in a cluster reaches a predetermined value, the data included in the cluster to the different groups.

13. The non-transitory computer-readable recording medium according to any one of claim 8, wherein the process further comprises comparing calculated first matching time calculated immediately with second matching time being time taken to match the matching data that is to be created when immediately previous allocation is performed at the allocating with each of the plurality of pieces of data in the database and determining, on the basis of a comparison result, whether the plurality of pieces of data are allocated to the groups, wherein
when it is determined that the plurality of pieces of data are allocated to the groups, the allocating includes allocating the plurality of pieces of data to the groups.

14. An evaluation method executed by a computer, the evaluation method comprising:
creating, using a processor, from a plurality of pieces of data in a database, matching data to be matched with the plurality of pieces of data;
calculating, using the processor, matching time for each of the plurality of pieces of data in the database, the matching time to be taken to match the each of the plurality of pieces of data with the matching data; and
allocating, using the processor, the plurality of pieces of the data to a plurality of groups based on the matching time for each of the plurality of pieces of data.

15. The evaluation method according to claim 14, wherein
the creating includes creating multiple pieces of matching data that are used to normalize the plurality of pieces of data, and
the calculating the matching time includes calculating, for each of the plurality of pieces of data, the matching time being time taken to match each of the plurality of pieces of data with each of a plurality of pieces of the created matching data.

16. The evaluation method according to claim 15, further comprising calculating, using the processor, a feature value from multiple pieces of the matching time, wherein
the creating includes creating a plurality of pieces of the matching data,
the calculating the matching time includes calculating, for each of the plurality of pieces of the data, matching time being time taken to match each of the plurality of pieces of the data with each of the plurality of pieces of the matching data,
the calculating the feature value includes calculating, for each of the plurality of pieces of data, a feature value from a plurality of pieces of the calculated matching time, and
the allocating includes comparing the calculated feature values and allocating each of the plurality of pieces of the data in a group such that pieces of data having closer feature values are allocated to different groups when compared with pieces of data having greatly different feature values.

17. The evaluation method according to claim 14, wherein
the creating includes specifying, from among the pieces of the calculated matching time for each of the plurality of pieces of data in the database, a piece of data in which the minimum matching time is calculated as subsequent matching data, until a predetermined number of the matching time is calculated,
the calculating the matching time includes calculating, for each of the plurality of pieces of data, matching time taken to match each of the plurality of pieces of the data with the subsequent matching data, until the predetermined number of the matching time is calculated.

18. The evaluation method according to claim 17, wherein
the calculating the feature value includes calculating, as the feature value and for each of the plurality of pieces of data, the average value of the matching time and the variance of the matching time, and
the allocating includes allocating the plurality of pieces of data on the coordinates in which the calculated average value and the calculated variance are used as two axes, performing clustering on the plurality of pieces of data on the coordinates, and allocating, when the number of pieces of the data included in a cluster reaches a predetermined value, the data included in the cluster to the different groups.

19. The evaluation method according to claim 15, further comprising comparing, using the processor, calculated first matching time calculated immediately with second matching time being time taken to match the matching data that is to be created when immediately previous allocation is performed at the allocating with each of the plurality of pieces of data in the database and determining, on the basis of a comparison result, whether the plurality of pieces of data are allocated to the groups, wherein
when it is determined that the plurality of pieces of data are allocated to the groups, the allocating includes allocating the plurality of pieces of data to the groups.

20. The evaluation method according to claim 15, wherein
the creating includes calculating the average value of elements included in the plurality of pieces of data in the database and creating average data in which the calculated average value is included in each of the elements, and
the calculating the matching time includes calculating, for each of the plurality of pieces of data, matching time taken to match the created average data with each of the plurality of pieces of data.
